(19) United States
(12) Patent Application Publication
(10) Pub. No.: US 2006/0060283 A1
(43) Pub. Date: Mar. 23, 2006

(54) Structure of wheel rim assembly

(76) Inventor: Yueh Nu Chen, Lan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/919,244

(22) Filed: Aug. 17, 2004

(51) Int. Cl. B60C 17/04

(52) U.S. Cl. 152/520

(57) ABSTRACT

A wheel rim is constructed to include a wheel rim body holding a tire, and a supplementary tire support mounted on a flange around the periphery of the wheel rim body for supporting the tire for enabling the car to run to a repair shop in case the tire is broken during running.

### BACKGROUND OF THE INVENTION

1. Field of the Invention

The present invention relates generally to a wheel rim and more particularly, to an improved structure of wheel rim assembly with tire anti-knocking anti-breaking protection.

2. Description of the Related Art

When the tire of a vehicle wheel is inflated, high-pressure air supports the tire in shape for running on the road. If a pointed body pierced the tire, the broken tire becomes unable to support the vehicle wheel for normal running on the road, and the broken tire must be repaired immediately. However, It is dangerous if one of the wheels of a vehicle is broken during a high speed running.

### SUMMARY OF THE INVENTION

The present invention has been accomplished under the circumstances in view. It is the main object of the present invention to provide a wheel rim for vehicle tire, which supports the tire in shape for enabling the car to run to a repair shop in case the tire is broken during running.

### BRIEF DESCRIPTION OF THE DRAWINGS

FIG. 1 is a cross sectional view showing a wheel rim assembly installed in a vehicle tire according to the present invention.

FIG. 2 is a schematic drawing showing the structure of a joint block according to the present invention.

FIG. 3 is an exploded view of a part of a supplementary tire support according to the present invention.

FIG. 4 is an exploded view of another part of the supplementary tire support according to the present invention.

FIG. 5 is a bottom view of the supplementary tire support according to the present invention.

FIG. 6 is a cross sectional view of a vehicle wheel constructed according to the present invention.

FIG. 7 is a schematic drawing showing the broken tire supported on the supplementary tire support around the wheel rim according to the present invention.

### DETAILED DESCRIPTION OF THE INVENTION

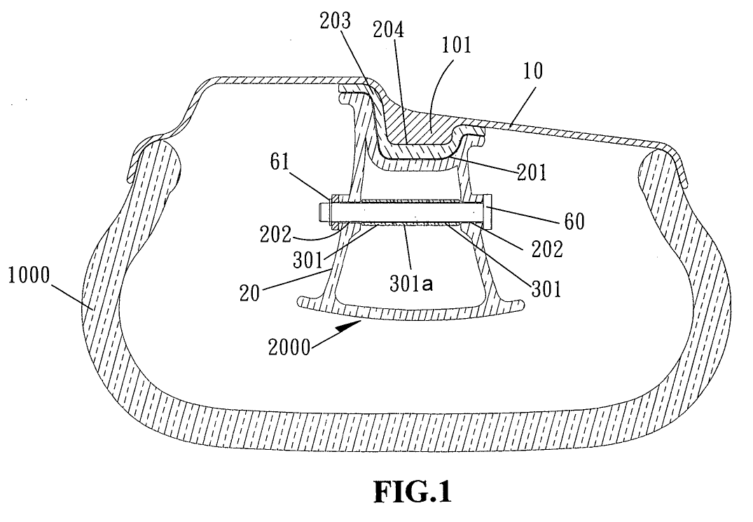

Referring to FIG. 1, a wheel rim assembly in accordance with the present invention is shown comprised of a wheel rim body 10, and a supplementary tire support 2000 mounted around the periphery of the wheel rim body 10. The wheel rim body 10 comprises a flange 101 extended around the periphery on the middle (see FIG. 1). The cross section of the flange 101 can be made having any of a variety of shapes.

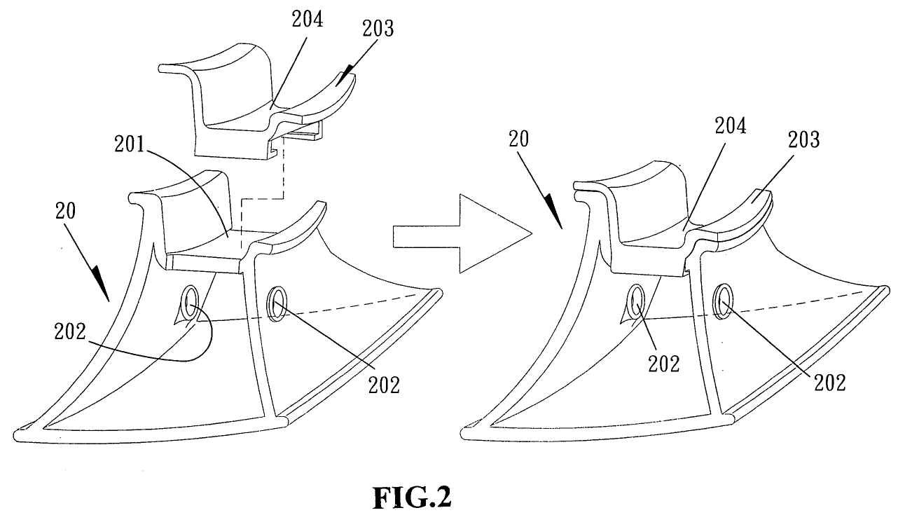

Referring to FIG. 2 and FIG. 1 again, the supplementary tire support 2000 is comprised of a plurality of joint blocks 20, a plurality of links 30, a first end connecting member 40, a second end connecting member 40a, and a screw bolt 50.

The joint blocks 20 are hollow block members (see FIGS. 1 and 2), each having a top recess 201 fixedly mounted with a packing pad 203, and two through holes 202 axially aligned at two opposite lateral sides. The packing pad 203 has a recessed portion 204 fitting the flange 101 of the wheel rim body 10. The bottom side of each joint block 20 has a rhombic shape (see FIG. 5).

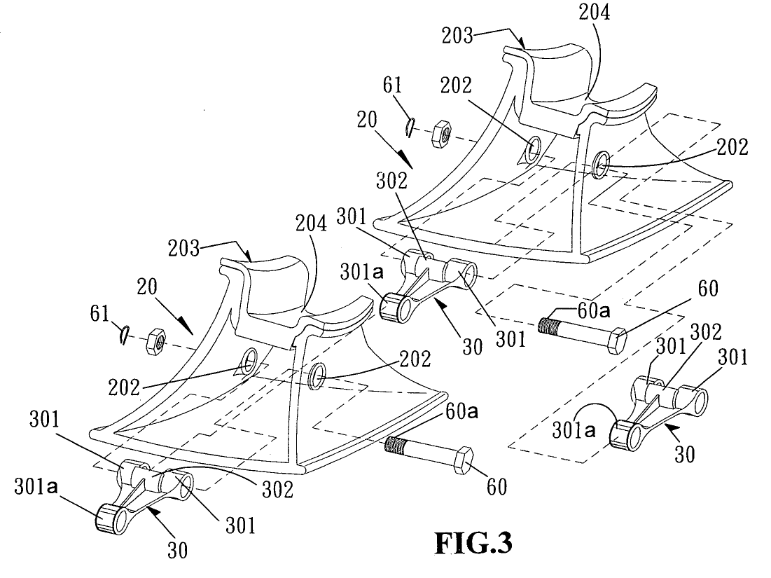

The links 30 connect the joint blocks 20 in series, each comprising a front barrel 301a transversely disposed at the front side, two rear barrels 301 transversely aligned at the rear side, and an arched bearing portion 302 transversely disposed at the rear side and connected between the rear barrels 301 (see FIG. 3).

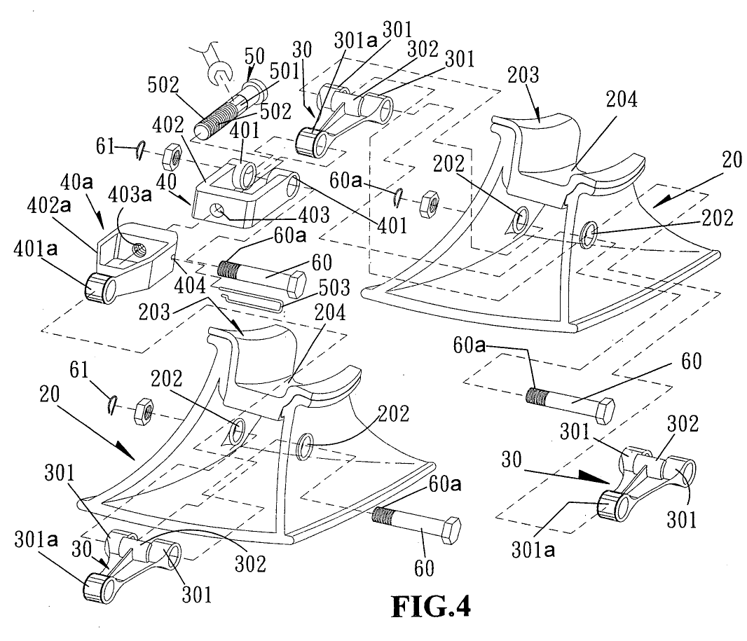

The first end connecting member 40 and the second end connecting member 40a are connected together to join the ends of the series of joint blocks 20 (see FIG. 4). The first end connecting member 40 comprises a U-shaped base frame 402, two transverse barrels 401 respectively fixedly provided at the ends of the U-shaped base frame 402, and a through hole 403 extended through the middle part of the U-shaped base frame 402 (see FIG. 4). The second end connecting member 40a comprises a base frame 402a, a barrel 401 fixedly transversely provided at the front side of the base frame 402a, a screw hole 403a axially defined in the rear side of the base frame 402a, and a pin hole 404 formed in one lateral side of the base frame 402a (see FIG. 4).

The screw bolt 50 is inserted through the through hole 403 of the first end connecting member 40 and threaded into the screw hole 403a of the second end connecting member 40a to secure the first end connecting member 40 and the second end connecting member 40a together, having a polygonal shoulder 501 for the grasping of a wrench or the like that is used to drive the screw bolt 50 into the screw hole 403a of the second end connecting member 40a and a series of transverse pin holes 502 (see FIG. 4). A pin 503 is inserted through the pin hole 404 of the base frame 402a of the second end connecting member 40a into one pin hole 502 of the screw bolt 50 to lock the screw bolt 50 to the second end connecting member 40a.

Referring to FIGS. 1-4 again, by means of connecting the barrels 301;301a of the links 30 and the barrels 401;401a of the end connecting members 40;40a to the through holes 202 of the joint blocks 20 with screw bolts 60, the rim support 200 and the joint blocks 20 with the links 30 and the end connecting members 40;40a are fastened together, thereby forming the desired supplementary tire support 2000 around the periphery of the wheel rim body 10 within the tire 1000. After insertion of the screw bolt 60 into the through holes 202 of one joint block 20 to connect the rear barrels 301 of one link 30 to the front barrel 301a of another link 30 transversely disposed at the front side, two rear barrels 301, a pin 61 is fastened to a pin hole 60a in the rear end of the screw bolt 60 to secure the screw bolt 60 to the respective joint block 20.

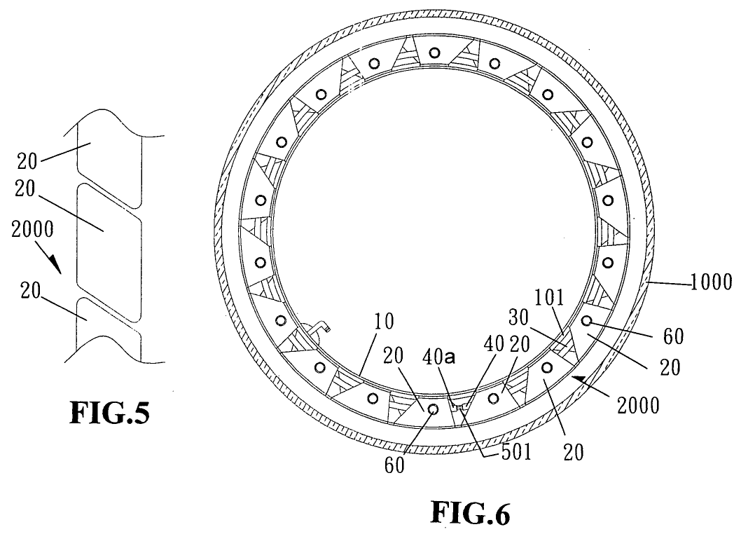

Referring to FIG. 6, the supplementary tire support 2000 is mounted inside the tire 1000, and then the wheel rim body 10 is inserted into the inside of the tire 1000 and fixedly fastened to the tire 1000, and then the hand is inserted into the tire 1000 to push the supplementary tire support 2000, forcing the recessed portion 204 of each joint block 20 into engagement with the flange 101 of the wheel rim body 10 (see FIGS. 1, 2 and 6), and then the screw bolt 50 is inserted through the through hole 403 of the first end connecting member 40 and threaded into the screw hole 403a of the second end connecting member 40a and fastened tight with a wrench to affix the supplementary tire support 2000 to the flange 101 of the wheel rim body 10, and then the pin 503 is inserted through the pin hole 404 of the base frame 402a of the second end connecting member 40a into one pin hole 502 of the screw bolt 50 to lock the screw bolt 50 to the second end connecting member 40a.

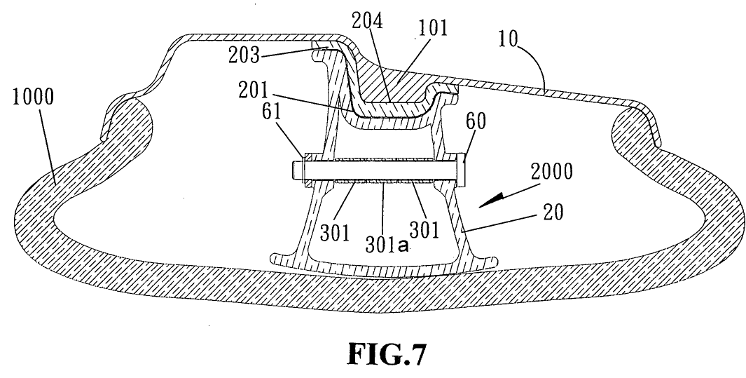

Referring to FIG. 7, when the tire 1000 is broken, the supplementary tire support 2000 support the broken tire 1000, enabling the driver to drive the car to a vehicle repair shop for repair.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A wheel rim comprising a wheel rim body holding a tire, said wheel rim body comprising a flange extended around the periphery thereof on the middle, and a supplementary tire support mounted on said flange of said wheel rim body and adapted to support said tire in shape in case said tire is broken during running, said supplementary tire support comprising:
a plurality of joint blocks, said joint blocks each having a top recess fixedly mounted with a packing pad that fits over said flange of said wheel rim body, and two through holes aligned at two opposite lateral sides thereof;
a plurality of links adapted to connect said joint blocks into a series of joint blocks, said links each having a front barrel transversely disposed at a front side, two rear barrels transversely aligned at a rear side, and an arched bearing portion connected between the two rear barrels, the front barrel of one said link being connectable between the two rear barrels of another of said links and between the two through holes of one said joint block;
a first end connecting member and a second end connecting member adapted to join the ends of said series of joint blocks, said first end connecting member comprising a U-shaped base frame, two barrels respectively provided at two ends of the U-shaped base frame and aligned in a line, and a through hole extending across a middle part of said U-shaped base frame, said second end connecting member comprising a base frame, a screw hole defined in a rear side of the base frame, a barrel transversely disposed at a front side of the base frame, and a pin hole through one lateral sidewall of the base frame;
a first screw bolt inserted through the through hole of the U-shaped base frame of said first end connecting member and threaded into the screw hole of the base frame of said second end connecting member, said first screw bolt having a plurality of transversely extended pin holes;
a first pin fastened to the pin hole of said second end connecting block and one pin hole of said first screw bolt to lock said first screw bolt to said second end connecting member;
a plurality of second screw bolts respectively inserted through the through holes of said end blocks and the barrels of said links to join said end blocks and said links, said second screw bolt each having a pin hole near a rear end thereof; and
a plurality of second pins respectively fastened to the pin holes of said second screw bolts to secure said second screw bolts to said end blocks.
